(19) United States
(12) Patent Application Publication
(10) Pub. No.: US 2017/0077718 A1
(43) Pub. Date: Mar. 16, 2017

(54) Electronic Device Charging Assembly

(71) Applicant: Jamar McDuffie, Buffalo, NY (US)

(72) Inventor: Jamar McDuffie, Buffalo, NY (US)

(21) Appl. No.: 14/851,834

(22) Filed: Sep. 11, 2015

(51) Int. Cl. H02J 7/00

(52) U.S. Cl. CPC H02J 7/007; H02J 7/0045; H02J 7/0047; H02J 2007/005

(57) ABSTRACT

An electronic device charging assembly includes a regulated power supply mounted therein. A pair of male prongs electrically coupled to the regulated power supply engage a female power socket to supply electrical power to the regulated power supply. An outlet port is electrically coupled to the regulated power supply. A power cord is coupled to the outlet port and is engaged an electronic device to transfer electrical power from the regulated power supply to a battery of the electronic device. A charge measuring system is electrically coupled to the outlet port and measures an electrical power level of the battery. The charge measuring system stops electrical power from the regulated power supply to the battery when the charge measuring system detects the battery is fully charged.

### BACKGROUND OF THE DISCLOSURE

### Field of the Disclosure

The disclosure relates to charging devices and more particularly pertains to a new charging device configured to fully charge a battery of an electronic device and cutting power to the battery once the battery is fully charged.

### SUMMARY OF THE DISCLOSURE

An embodiment of the disclosure meets the needs presented above by generally comprising a housing that has a front wall, a rear wall and a perimeter wall which is attached to and extends between the front and rear walls. A regulated power supply is mounted within the housing. A pair of male prongs is electrically coupled to the regulated power supply and extends outwardly from the housing. The male prongs engage a female power socket to supply electrical power to the regulated power supply. An outlet port is mounted on the housing and is electrically coupled to the regulated power supply. A power cord is removably coupled to the outlet port. The power cord is engaged an electronic device to transfer electrical power from the regulated power supply to a battery of the electronic device. A charge measuring system is electrically coupled to the outlet port and measures an electrical power level of the battery. The charge measuring system stops electrical power from the regulated power supply to the battery when the charge measuring system detects the battery is fully charged.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of an electronic device charging assembly according to an embodiment of the disclosure.

FIG. 2 is a rear view of an embodiment of the disclosure.

FIG. 3 is a bottom view of an embodiment of the disclosure.

FIG. 4 is a side view of an embodiment of the disclosure.

FIG. 5 is a front view of displays of an embodiment of the disclosure.

FIG. 6 is a schematic view of an embodiment of the disclosure.

### DESCRIPTION OF THE PREFERRED EMBODIMENT

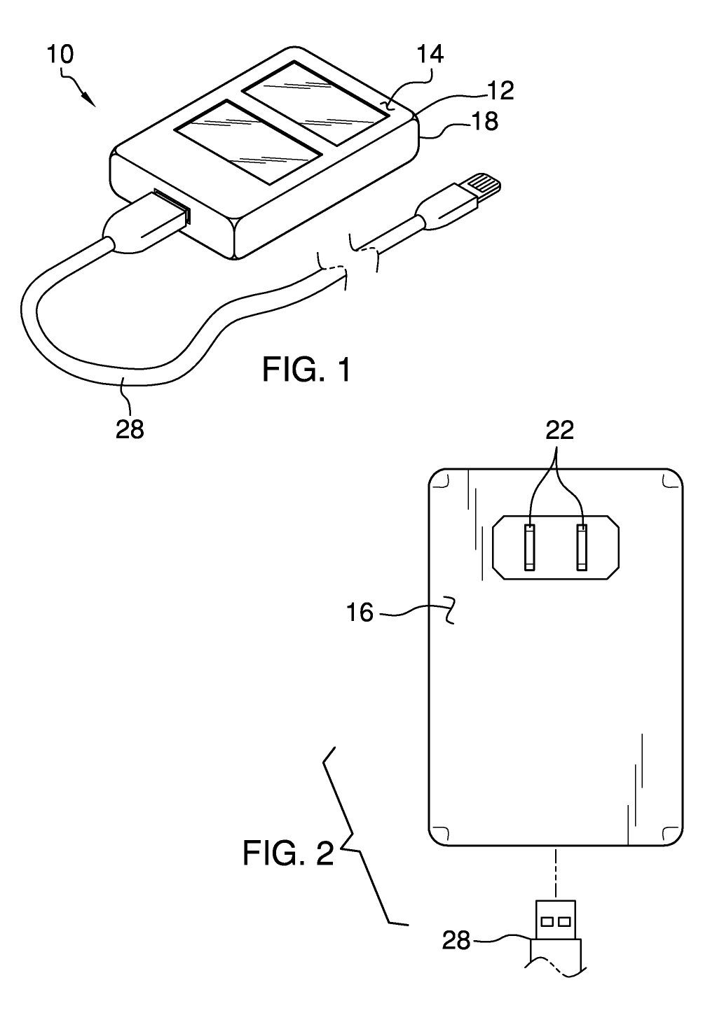

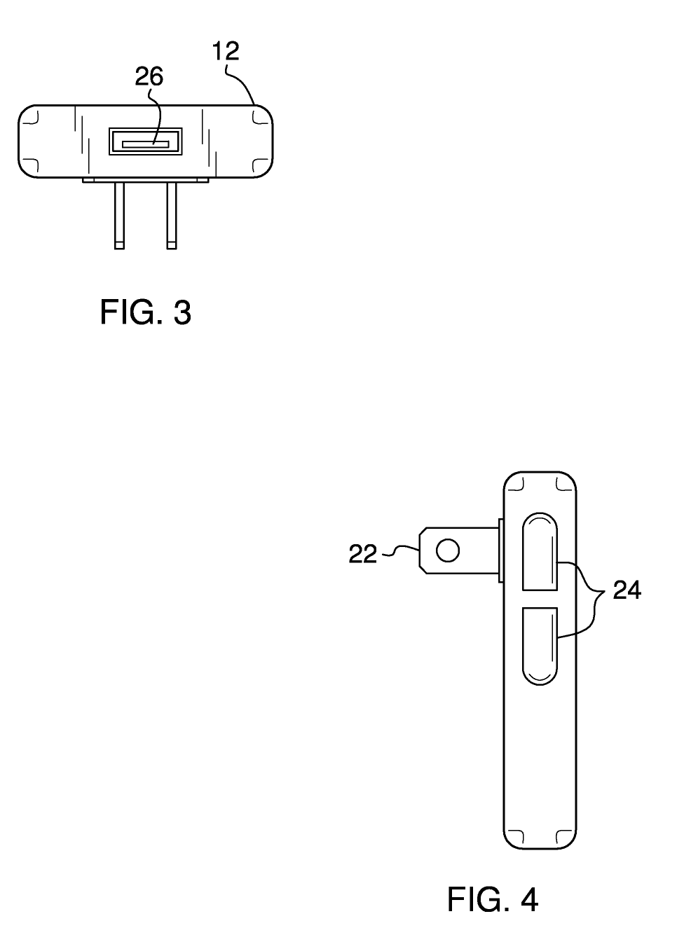

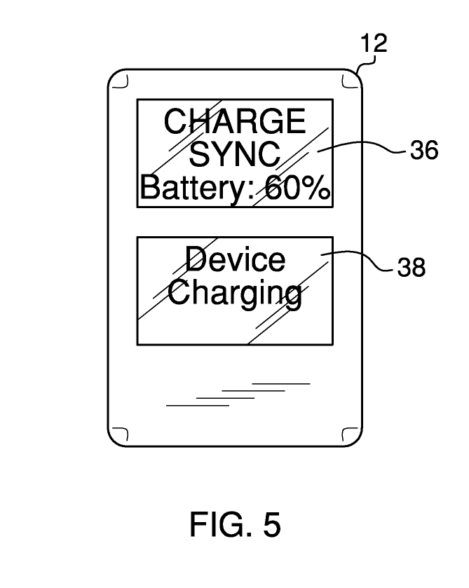

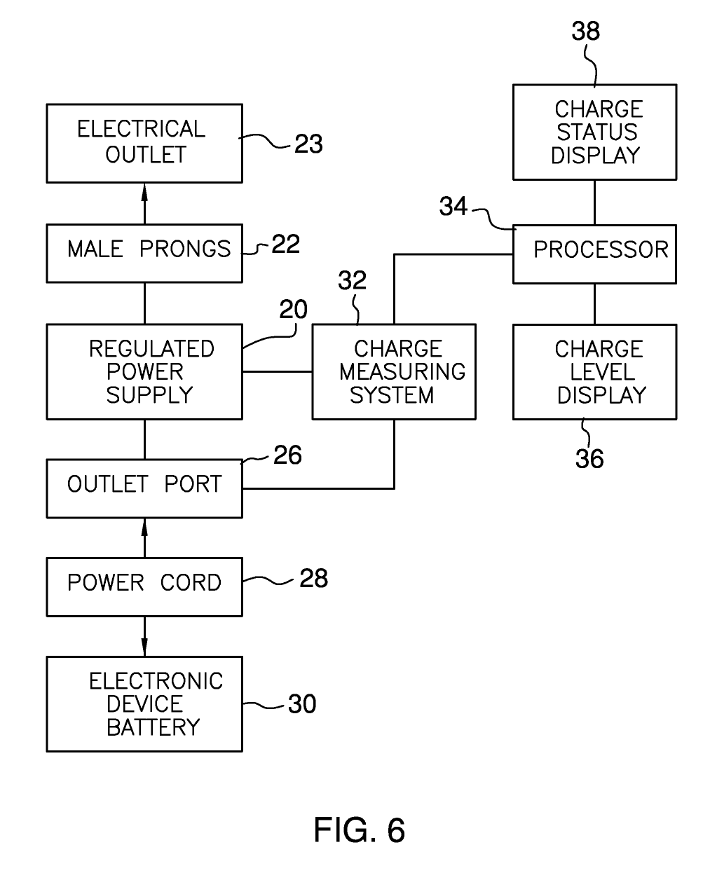

With reference now to the drawings, and in particular to FIGS. 1 through 6 thereof, a new charging device embodying the principles and concepts of an embodiment of the disclosure and generally designated by the reference numeral 10 will be described.

As best illustrated in FIGS. 1 through 6, the electronic device charging assembly 10 generally comprises a housing 12 that has a front wall 14, a rear wall 16 and a perimeter wall 18 which is attached to and extends between the front 14 and rear 16 walls. A regulated power supply 20 is mounted within the housing 12. The regulated power supply 20 is conventional to small, personal electronic device chargers such as those used will cellular phones, laptop computers, tablet computers and the like. Thus, it may include a transformer, rectifier, filter and regulator wherein an electrical input is connected to the transformer and an electrical output is connected to the regulator. A pair of male prongs 22 is electrically coupled to the regulated power supply 20 and extends outwardly from the housing 12. The male prongs 22, serving an electrical input, are configured to engage a female power socket, or electrical outlet 23, to supply electrical power to the regulated power supply 20. Switches 24 may be provided which are included with the regulated power supply 20 to selectively alter its functions such as turning charging on or off.

An outlet port 26, functioning as the electrical output, is mounted on the housing 12 and is electrically coupled to the regulated power supply 20. The outlet port 26 may include any conventional design used depending on the type of electronic device being powered and therefore may have a structure particular to that electronic device. A power cord 28 is removably coupled to the outlet port 26 and is configured to engage an electronic device to transfer electrical power from the regulated power supply 20 to a battery 30 of the electronic device.

A charge measuring system 32 is electrically coupled to the outlet port 26 and is configured to measure an electrical power level of the battery 30. More particularly, the charge measuring system 32 may be what is known as a state of charge meter. Such meters may work by measuring voltage or coulomb counting. The charge measuring system 32 may include a processor 34 programmed to recognize the electrical device to which the charge measuring system is engaged so that it may electronically record the amount of electricity supplied to the electrical device so that self-calibrating may take place to account for battery storage loss over time. Alternatively, the processor 34 may communicate with a control system of the electronic device which tracks the amount of electricity used by the battery 30 since its last full charge. The charge measuring system 32 stops electrical power from the regulated power supply 20 to the battery 30 when the charge measuring system 32 detects the battery 30 is fully charged.

A charge level display 36 is mounted on the housing 12 and is operationally coupled to the charge measuring system 32. The charge level display 36 indicates a charge state of the battery 30 relative to a full charge. The charge level display 36 may show a numerical percentage or a may include a representation such as a bar graph or other image indicating the percentage of full charge obtained.

A charge status display 38 is mounted on the housing 12 and is operationally coupled to the charge measuring system 32. The charge status display 38 indicates when the regulated power supply 20 is supplying electrical power to the battery 30 and when electrical power has been stopped. Each of the charge lever 36 and charge status 38 displays may comprise LCD displays.

In use, the assembly 10 is used for powering an electronic device in a conventional manner. However, the assembly 10 includes a charge measuring system 32 which is independent from the electronic device to ensure that the battery 30 of the electronic device is fully charged properly and that the assembly 10 stops sending electricity to the battery once the battery 30 is fully charged.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electronic device charging assembly configured to be electrically coupled to and charge a battery of an electronic device, said assembly comprising:
a housing having a front wall, a rear wall and a perimeter wall being attached to and extending between said front and rear walls;
a regulated power supply being mounted within said housing, a pair of male prongs being electrically coupled to said regulated power supply and extending outwardly from said housing, said male prongs being configured to engage a female power socket to supply electrical power to said regulated power supply;
an outlet port being mounted on said housing and being electrically coupled to said regulated power supply, a power cord being removably coupled to said outlet port, said power cord being configured to engage an electronic device to transfer electrical power from said regulated power supply to a battery of said electronic device; and
a charge measuring system being electrically coupled to said outlet port and being configured to measure an electrical power level of the battery, said charge measuring system stopping electrical power from said regulated power supply to the battery when said charge measuring system detects the battery is fully charged.

2. The electronic device charging assembly according to claim 1, further including a charge level display being mounted on said housing and being operationally coupled to said charge measuring system, said charge level display indicating a charge state of the battery relative to a full charge.

3. The electronic device charging assembly according to claim 1, further including a charge status display being mounted on said housing and being operationally coupled to said charge measuring system, said charge status indicating when said regulated power supply is supplying electrical power to the battery and when electrical power has been stopped.

4. An electronic device charging assembly configured to be electrically coupled to and charge a battery of an electronic device, said assembly comprising:
a housing having a front wall, a rear wall and a perimeter wall being attached to and extending between said front and rear walls;
a regulated power supply being mounted within said housing, a pair of male prongs being electrically coupled to said regulated power supply and extending outwardly from said housing, said male prongs being configured to engage a female power socket to supply electrical power to said regulated power supply;
an outlet port being mounted on said housing and being electrically coupled to said regulated power supply, a power cord being removably coupled to said outlet port, said power cord being configured to engage an electronic device to transfer electrical power from said regulated power supply to a battery of said electronic device;
a charge measuring system being electrically coupled to said outlet port and being configured to measure an electrical power level of the battery, said charge measuring system stopping electrical power from said regulated power supply to the battery when said charge measuring system detects the battery is fully charged;
a charge level display being mounted on said housing and being operationally coupled to said charge measuring system, said charge level display indicating a charge state of the battery relative to a full charge; and
a charge status display being mounted on said housing and being operationally coupled to said charge measuring system, said charge status indicating when said regulated power supply is supplying electrical power to the battery and when electrical power has been stopped.
